(19) United States
(12) Patent Application Publication
(10) Pub. No.: US 2023/0162161 A1
(43) Pub. Date: May 25, 2023

(54) PROVIDING SERVICE OPERATIONS BASED ON SERVICE AND FEEDBACK DATA

(71) Applicant: Pioneer, LLC, Potomac, MD (US)

(72) Inventors: Karina Neff, Burke, VA (US); Chase Carlson, Gaithersburg, MD (US); Dana Boyce, Denver, CO (US)

(21) Appl. No.: 17/991,653

(22) Filed: Nov. 21, 2022

Related U.S. Application Data
(60) Provisional application No. 63/317,761, filed on Mar. 8, 2022.
(60) Provisional application No. 63/282,109, filed on Nov. 22, 2021.

(51) Int. Cl. G06Q 10/20; G06Q 50/10

(52) U.S. Cl. CPC G06Q 10/20; G06Q 50/10

(57) ABSTRACT

A method includes identifying service data associated with a service zone. The service data includes a plurality of service records and a corresponding timestamp for each of the plurality of service records. The method further includes identifying feedback data associated with the service zone. The feedback data includes one or more of a service work order, a supplies work order, a service ranking, or sensor data. The method further includes determining, based on the service data and the feedback data, a corrective action associated with the service zone. The method further includes causing performance of the corrective action associated with the service zone.

### RELATED APPLICATIONS

This application claims benefit of U.S. Provisional Patent Application No. 63/317,761, filed Mar. 8, 2022, and U.S. Provisional Patent Application No. 63/282,109, filed Nov. 22, 2021, the entire contents of which are incorporated by reference herein in their entirety.

### TECHNICAL FIELD

Embodiments of the present disclosure relate to providing service operations, and in particular to providing service operations based on service data and feedback data.

### BACKGROUND

Service operations are provided at many different types of locations. Service operations can include cleaning operations, disinfecting operations, re-supplying operations, etc.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a block diagram illustrating an exemplary system architecture, according to certain embodiments.

FIGS. 2A-F illustrate graphical user interfaces (GUIs) associated with providing service operations, according to certain embodiments.

FIG. 3 illustrates a GUI associated with providing service operations, according to certain embodiments.

FIG. 4 illustrates a GUI associated with providing service operations, according to certain embodiments.

FIG. 5 illustrates a data set generator to create data sets for a machine learning model associated with providing service operations, according to certain embodiments.

FIG. 6 is a block diagram illustrating determining predictive data associated with providing service operations, according to certain embodiments.

FIGS. 7A-E illustrate flow diagrams of methods associated with providing service operations, according to certain embodiments.

FIG. 8 is a block diagram illustrating a computer system, according to certain embodiments.

### DETAILED DESCRIPTION OF EMBODIMENTS

Embodiments described herein are related to providing service operations based on service data and feedback data.

Service operations are provided at many different types of locations. For example, service organizations may provide service operations, such as cleaning operations (e.g., day porter, day cleaning, night cleaning, maintenance and engineering), disinfecting operations, re-supplying operations, landscaping operations, vegetation maintenance, emergency operations, pandemic response operations, air quality operations, restoration operations (e.g., tile and grout restoration, stone restoration, etc.), electrostatic misting operations, etc. These service operations may be provided for locations such as restrooms, common areas, offices, restaurants, lobbies, hallways, living quarters, landscaped areas, potted plants, hotel rooms, patient rooms, etc. A service organization may include a cleaning company, maintenance company, engineering company, janitorial staff, etc.

Conventionally a building owner requests that a service organization provide particular service operations at a predetermined frequency (e.g., once a day at a predetermined time). Conventionally, the predetermined frequency is inadequate due to varied usage of locations over time. For example, due to an increase in patrons, excessive activity, adverse weather, etc. at a location, the location can become dirty and unhealthy (e.g., increased chance of slipping and falling, unhealthy services, restrooms with depleted supplies, etc.). Conventionally, a building owner receives complaints of an unclean location, the building owner calls the service organization to request unscheduled service operations, the service organization calls service staff until they find service staff that are available to provide the unscheduled service operations, the service organization calls the building owner to confirm that the unscheduled service operations can be performed, and the service organization dispatches the service staff to perform the service operations. Conventionally, this back and forth between the building owner, service organization, and service staff is performed via many client devices over a network. This leads to increased bandwidth used, increased processor overhead, and increased energy consumption. The back and forth also leads to prolonged time of an unclean location, unhealthy conditions for patrons, etc.

The devices, systems, and methods disclosed herein provide service operations based on service data and feedback data.

A processing device identifies service data associated with a service zone. The service data includes service records and a corresponding timestamp for each of the service records. For example, service records can include cleaning logs, disinfecting logs, refilling logs, sanitizing logs, service logs, etc. Each service record is associated with an identifier of the service zone and a timestamp.

The processing device identifies feedback data associated with the service zone. The feedback data can include one or more of a service work order, a supplies work order, a service ranking, or sensor data. The feedback data can be provided by a client device of a patron of the service zone responsive to scanning a quick response (QR) code located at the service zone. The QR code can be associated with the identifier of the service zone.

The processing device determines, based on the service data and the feedback data, a corrective action associated with the service zone. In some embodiments, the determining of the corrective is via a trained machine learning model that was trained with: data input of historical service data and historical feedback data; and target output of historical performance data (e.g., frequency of service operations, schedule of service operations). The corrective action may be an updated frequency of service operations, an updated schedule of service operations, etc.

The processing device causes performance of the corrective action. The performance of the corrective action may include causing service operations to be performed, sending an alert, causing reconfiguration of the service zone (e.g., adding a paper towel dispenser, adding a hand air dryer, etc.).

In some embodiments, the processing device causes a client device to display a GUI including a countdown until a scheduled servicing of the service zone, a graphical representation of one or more service records, a graphical element to receive the feedback data (e.g., service work order, supplies work order, service ranking), a graphical element configured to receive user input to subscribe to service notifications associated with the service zone, and/or the like.

The systems, devices, and methods of the present disclosure have advantages over conventional solutions. The present disclosure provides corrective actions (e.g., service operations) with less processor overhead, energy consumption, and bandwidth used compared to conventional solutions. The present disclosure provides cleaner and healthier zones compared to conventional solutions. In some embodiments, the present disclosure provides predictive service operations (e.g., schedule of service operations) to provide the cleaner and healthier zones compared to conventional solutions. The present disclosure provides patrons with transparency on the cleanliness and safety of a service zone.

Although portions of the present disclosure refer to cleaning operations and indoor spaces, the present disclosure can be applied to different types of service operations (e.g., landscaping operations, maintenance operations, etc.) and different types of locations (e.g., outdoor locations, industrial locations, etc.)

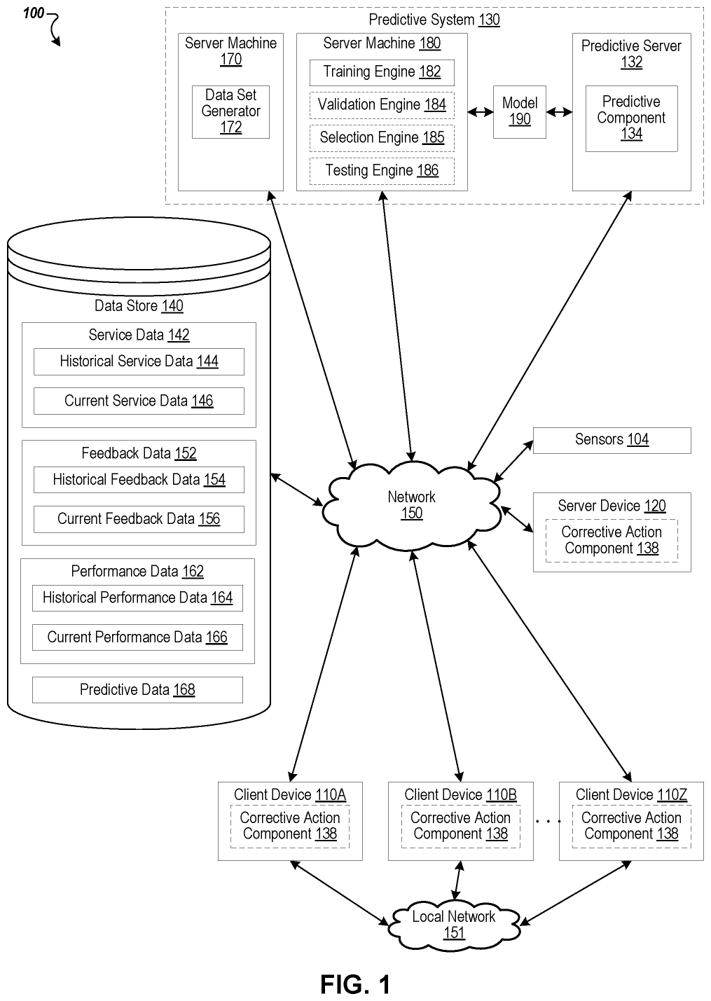

FIG. 1 is a block diagram illustrating an exemplary system 100 (e.g., exemplary system architecture), according to certain embodiments. The system 100 includes sensors one or more of 104, client devices 110A-Z (hereinafter “client device 110”), server device 120, predictive server 132, and/or data store 140. In some embodiments, predictive server 132 is part of predictive system 130. In some embodiments, predictive system 130 further includes server machines 170 and 180.

In some embodiments, one or more of sensors 104, client devices 110, predictive server 132, data store 140, server machine 170, and/or server machine 180 are coupled to each other via a network 150 (e.g., for generating predictive data 168, for controlling client devices 110, for performing corrective actions, etc.). In some embodiments, network 150 is a public network that provides server device 120 with access to the sensors 104, client devices 110, predictive server 132, data store 140, and other publically available computing devices. In some embodiments, network 150 is a private network that provides server device 120 access to sensors 104, client devices 110, predictive server 132, data store 140, and other privately available computing devices. In some embodiments, network 150 includes one or more Wide Area Networks (WANs), Local Area Networks (LANs), wired networks (e.g., Ethernet network), wireless networks (e.g., an 802.11 network or a Wi-Fi® network), cellular networks (e.g., a Long Term Evolution (LTE) network), radar units, transmission antenna, reception antenna, sonar devices, Lidar devices, routers, hubs, switches, server computers, cloud computing networks, and/or a combination thereof.

The client device 110 includes a computing device such as a personal computer (PC), laptop, mobile phone, smart phone, tablet computer, netbook computer, network connected television (“smart TV”), network-connected media player (e.g., Blu-ray player), a set-top box, over-the-top (OTT) streaming device, operator box, cloud server, cloud-based system (e.g., cloud service device, cloud network device), etc. The client device 110 may be capable of performing cloud-based operations (e.g., with sensors 104, server device 120, predictive system 130, data store 140, etc.).

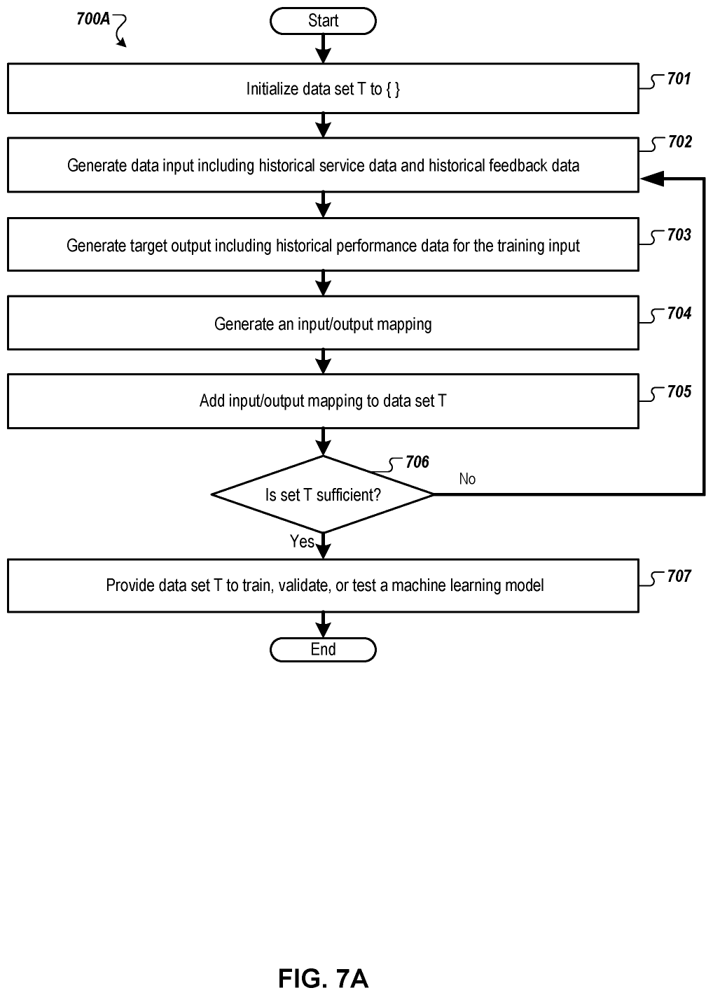

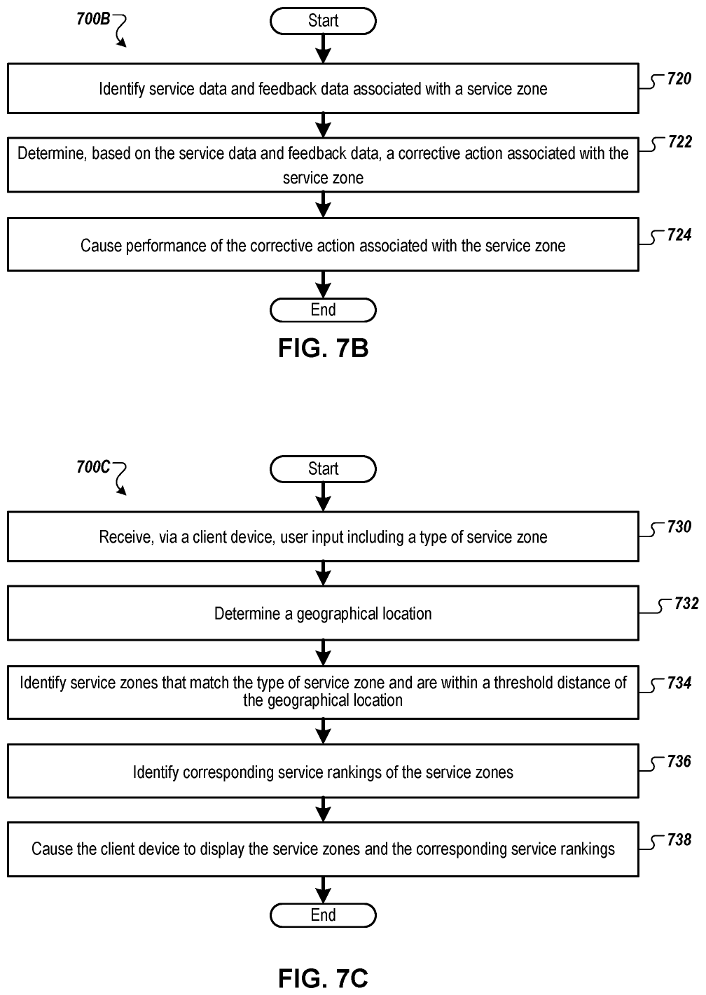

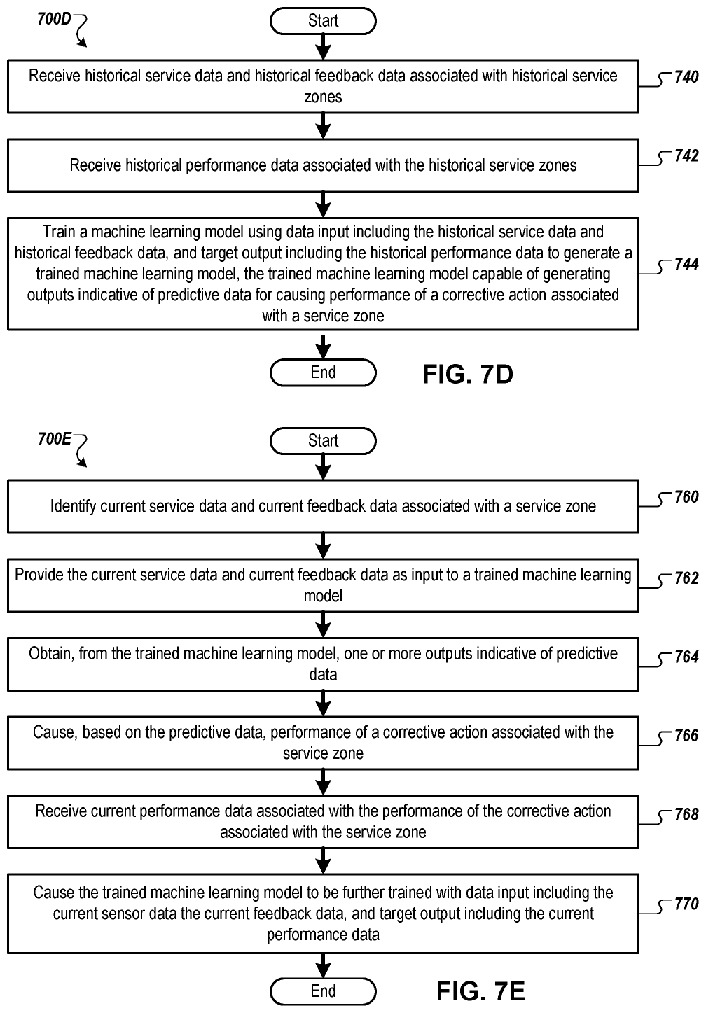

In some embodiments, client device 110 includes a corrective action component 138 to perform one or more methods (e.g., see FIGS. 7A-E) and/or to receive service data 142, feedback data 152, performance data 162, etc. In some embodiments, a client device 110 executes an application (e.g., web-based application executed on an internet browser, standalone application downloaded from an application store) to execute the corrective action component 138. In some embodiments, client device 110 displays a GUI (e.g., via an application, via corrective action component 138), where the GUI enables the user to provide, as input, service data 142, feedback data 152, performance data 162, etc.

The server device 120 includes one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), a cloud server, a system stored on one or more clouds, etc. In some embodiments, the controller 109 includes a corrective action component 138 to perform one or more methods (e.g., see FIGS. 7A-E) and/or to receive service data 142, feedback data 152, performance data 162, etc. Server device 120 includes an operating system that allows users to one or more of generate, view, or edit data.

In some embodiments, sensors 104 provide sensor data associated with a service zone. The sensors 104 may include one or more of imaging device (e.g., camera), heat sensor, temperature sensor, pressure sensor, flow sensor, humidity sensor, barometer, light-sensing sensor (e.g., irradiance sensor), electrical current sensor, voltage sensor, location sensor (e.g., global positioning system (GPS) device), occupancy sensor (e.g., a door sensor, key card access sensor), chemical sensor (e.g., swab sensor), air quality sensor (e.g., carbon dioxide (CO₂) sensor), etc. In some embodiments, one or more of sensors 104 are located in the service zone (e.g., mounted to a wall or ceiling of the service zone). In some embodiments, client device 110 includes one or more of sensors 104 (e.g., an imaging device, a location sensor, a light-sensing sensor, etc.). In some embodiments, one or more sensors 104 include sensor probes that measure sensor data including chemical and physical parameters. In some embodiments, the sensors 104 provide the sensor data during service operations, before service operations, after service operations, between service operations, a predetermined intervals, etc. The sensor data can include one or more of image data, chemical data, air quality data (e.g., CO2 data), occupancy data, temperature data, heat data, pressure data, flow data, humidity data, barometer data, light-sensing data, irradiance data, electrical current data, voltage data, location data, environmental conditions data (e.g., temperature, pressure, light, etc.), and/or the like.

In some embodiments, one or more client devices 110A-Z communicate with each other. In some embodiments, client device 110A receives data (e.g., instructions, schedule, sensor data, etc.) from one or more of sensors 104, server device 120, predictive system 130, and/or data store 140 and provides the data to the one or more client devices 110B-Z. In some embodiments, a client device 110A receives data from one or more other client devices 110B-Z and provides the data to one or more of sensors 104, server device 120, predictive system 130, and/or data store 140.

In some embodiments, one or more client devices 110A-Z communicate over network 150. In some embodiments, one or more client devices 110A-Z communicate over a local network 151. Local network 151 may be a computing network that provides one or more communication channels between client devices 110. In some examples, local network 151 is a peer-to-peer network that does not rely on a pre-existing network infrastructure (e.g., access points, switches, routers) and client devices 110 replace the networking infrastructure to route communications between the client devices 110. Local network 151 may be a wireless network that is self-configuring and enables client devices 110 to contribute to local network 151 and dynamically connect and disconnect from local network 151 (e.g., ad hoc wireless network). In some examples, local network 151 is a computing network that includes networking infrastructure that enables client devices 110 to communicate with other client devices 110. The local network 151 may or may not have access to the public network (e.g., internet, network 150). For example, an access point or device that may function as an access point to enable client devices 110 to communicate with one another without providing internet access. In some embodiments, the local network 151 provides access to a larger network such as network 150 (e.g., Internet). In some embodiments, local network 151 is based on any wireless or wired communication technology and may connect a first client device 110 directly or indirectly (e.g., involving an intermediate device, such as an intermediate client device 110) to a second client device 110. The wireless communication technology may include Bluetooth®, Wi-Fi®, infrared, ultrasonic, or other technology. The wired communication may include universal serial bus (USB), Ethernet, RS 232, or other wired connection. The local network 151 may be an individual connection between two client devices 110 or may include multiple connections.

In some embodiments, corrective action component 138 receives user input (e.g., service data 142 and/or feedback data 152 entered via a GUI displayed via client device 110) associated with a service zone. In some embodiments, the corrective action component 138 transmits the user input to the predictive system 130, receives output (e.g., predictive data 168) from the predictive system 130, determines a corrective action associated with the service zone based on the output, and causes the corrective action to be implemented. In some embodiments, the corrective action component 138 obtains service data 142 and feedback data 152 associated with the service zone (e.g., from data store 140, etc.) and provides the service data 142 and feedback data 152 associated with the service zone to the predictive system 130. In some embodiments, the corrective action component 138 stores service data 142 and feedback data 152 in the data store 140 and the predictive server 132 retrieves the service data 142 and feedback data 152 from the data store 140. In some embodiments, the predictive server 132 stores output (e.g., predictive data 168) of the trained machine learning model 190 in the data store 140 and the corrective action component 138 (e.g., of server device 120) retrieves the output from the data store 140. In some embodiments, the corrective action component 138 receives an indication of a corrective action from the predictive system 130 and causes the corrective action to be implemented.

In some embodiments, a corrective action is associated with one or more of Computational Process Control (CPC), Statistical Process Control (SPC) (e.g., SPC to compare to a graph of 3-sigma, etc.), Advanced Process Control (APC), model-based process control, preventative operative maintenance, design optimization, updating of operating parameters, feedback control, machine learning modification, or the like.

In some embodiments, the corrective action includes providing an alert (e.g., a notification to provide a service operation at a service zone if the predictive data 168 indicates a predicted abnormality, such as an abnormality of cleanliness or supplies). In some embodiments, the corrective action includes providing feedback control (e.g., modifying schedule of service operations responsive to the predictive data 168 indicating a predicted abnormality). In some embodiments, the corrective action includes providing machine learning (e.g., causing service operations based on the predictive data 168). In some embodiments, performance of the corrective action includes causing updates to one or more service operation parameters. In some embodiments, the corrective action includes causing performance of preventative maintenance.

In some embodiments, the predictive server 132, server machine 170, and server machine 180 each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

The predictive server 132 includes a predictive component 134. In some embodiments, the predictive component 134 receives service data 142 and feedback data 152 (e.g., receive from the server device 120, retrieve from the data store 140) and generates output (e.g., predictive data 168) for performing corrective action associated with the client device 110 based on the service data 142 and feedback data 152. In some embodiments, the predictive component 134 uses one or more trained machine learning models 190 to determine the output for performing the corrective action based on the service data 142 and feedback data 152. In some embodiments, trained machine learning model 190 is trained using historical service data 144, historical feedback data 154, and historical performance data 164.

In some embodiments, the predictive system 130 (e.g., predictive server 132, predictive component 134) generates predictive data 168 using supervised machine learning (e.g., supervised data set, labeled data, etc.). In some embodiments, the predictive system 130 generates predictive data 168 using semi-supervised learning (e.g., semi-supervised data set, a predictive percentage, etc.). In some embodiments the machine learning (e.g., semi-supervised machine learning) includes training with service data 142, feedback data 152, and performance data 162 that correspond to a threshold service rating (e.g., a 5-star rating). In some embodiments, the predictive system 130 generates predictive data 168 using unsupervised machine learning (e.g., unsupervised data set, clustering, etc.).

In some embodiments, the data store 140 is memory (e.g., random access memory), a drive (e.g., a hard drive, a flash drive), a database system, or another type of component or device capable of storing data. In some embodiments, data store 140 includes multiple storage components (e.g., multiple drives or multiple databases) that span multiple computing devices (e.g., multiple server computers). In some embodiments, the data store 140 stores one or more of service data 142, feedback data 152, performance data 162, and/or predictive data 168.

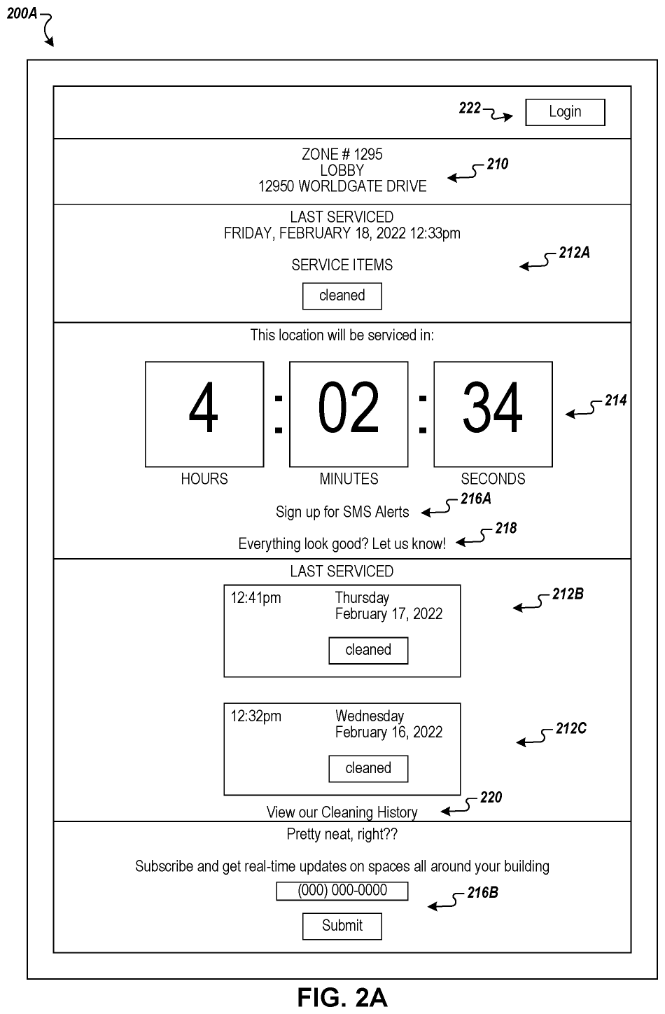

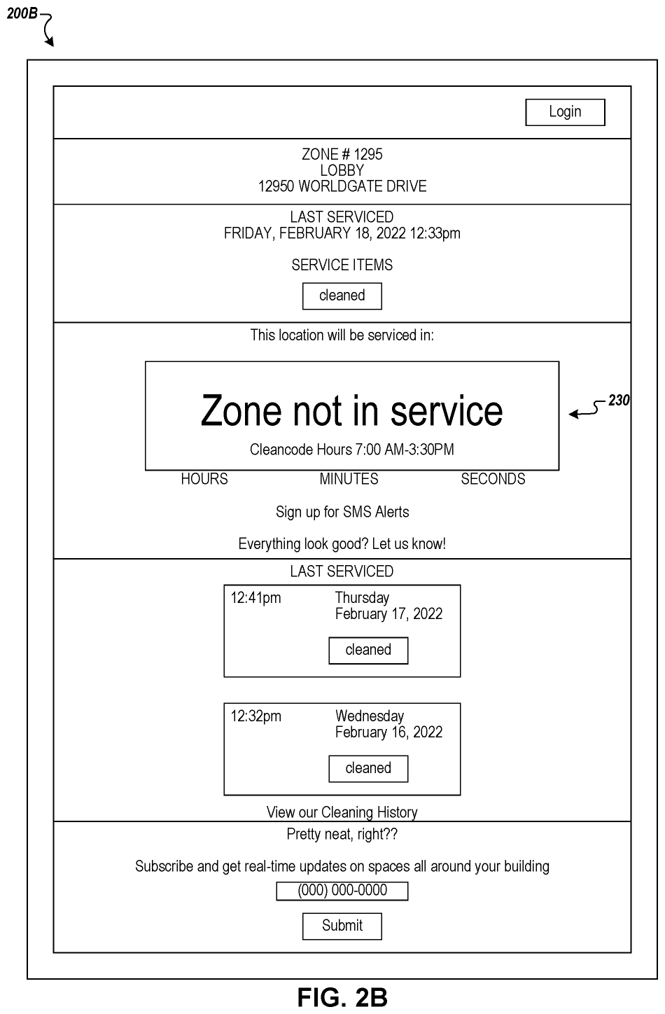

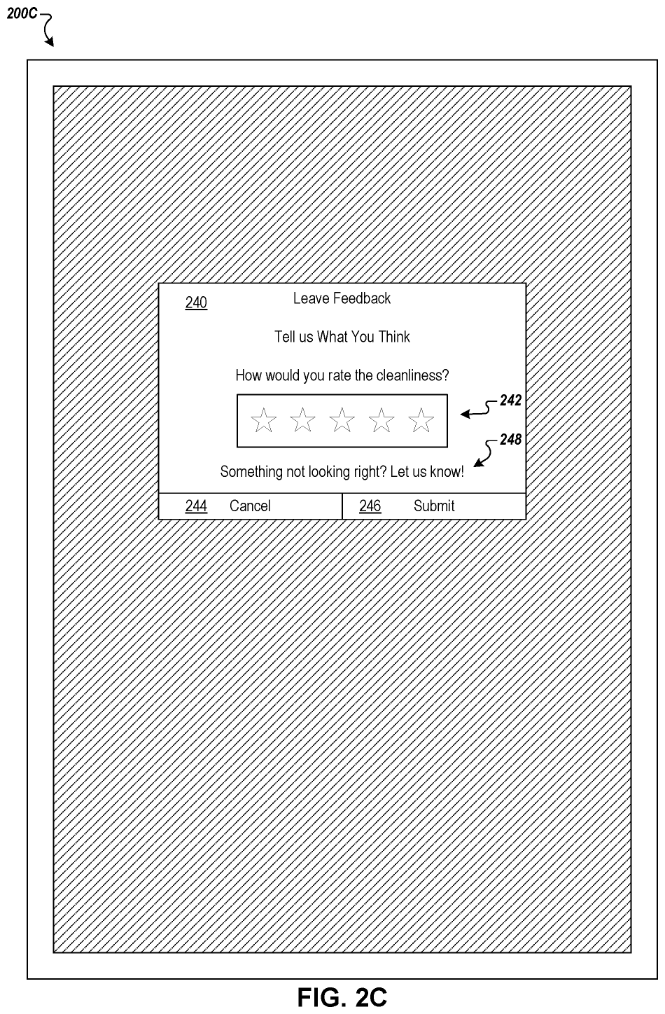

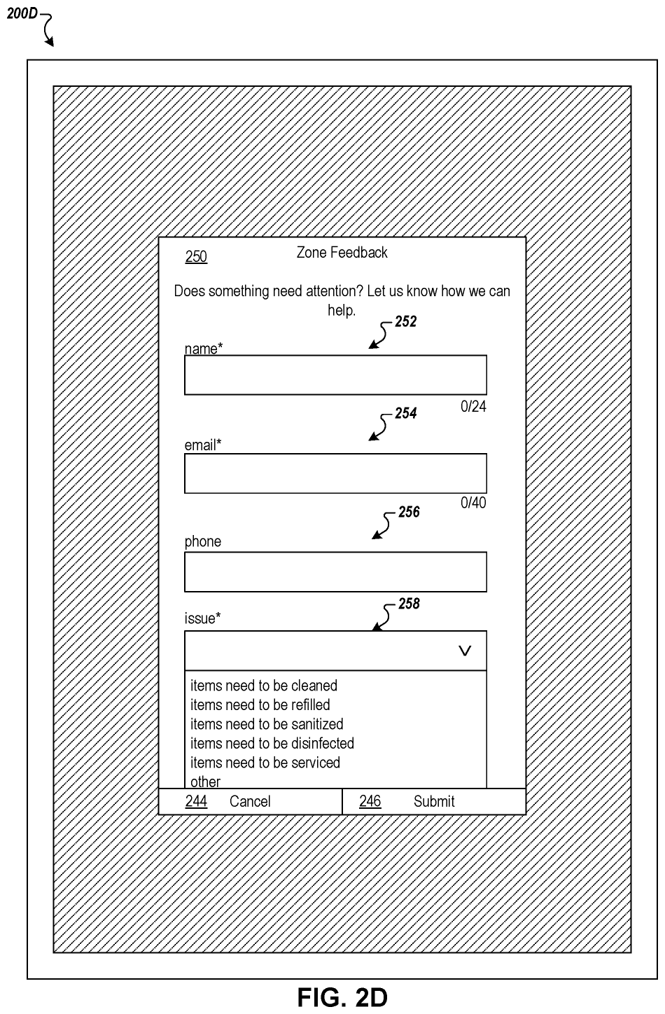

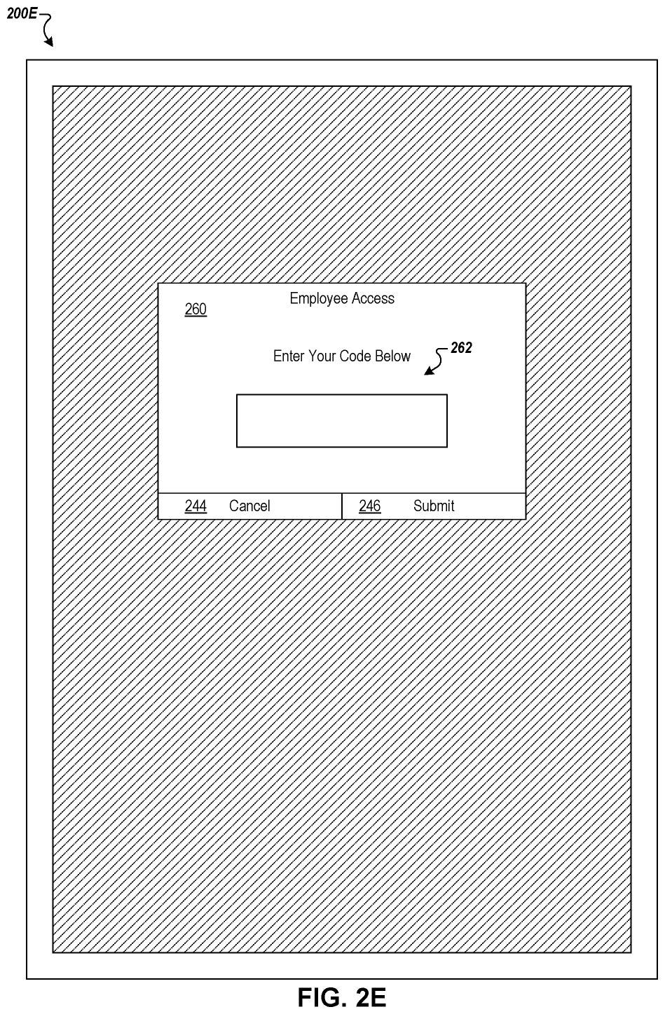

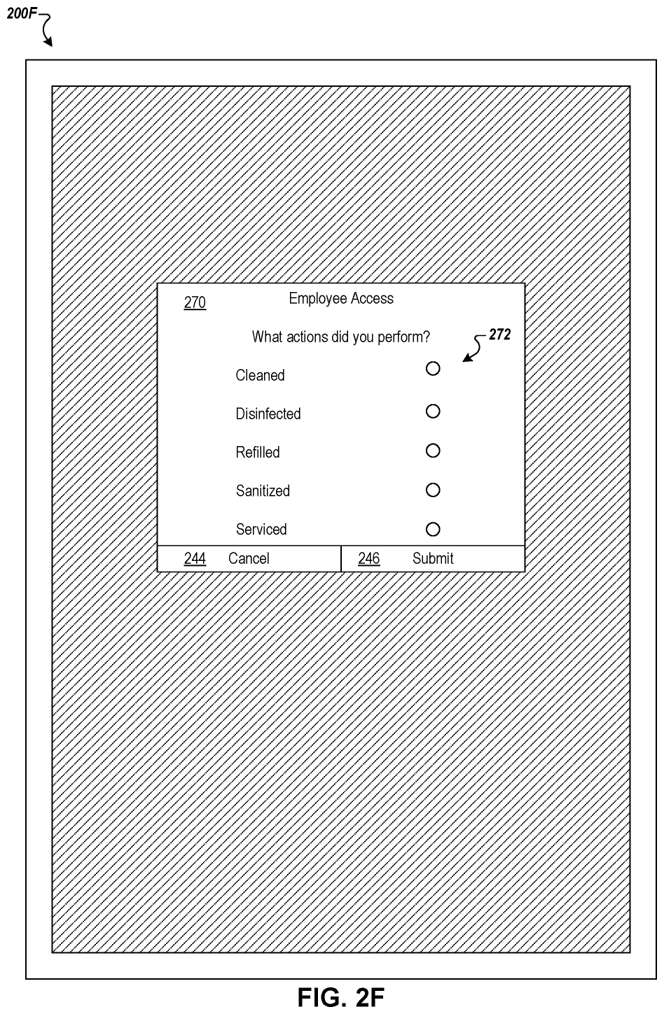

Service data 142 (e.g., historical service data 144 and current service data 146) includes service records and a corresponding timestamp. Each of the service records may correspond to a cleaning operation, disinfecting operation, refilling (e.g., re-supplying) operation, sanitizing operation, service operation, etc. Service records can include cleaning logs, disinfecting logs, refilling logs, sanitizing logs, service logs, etc. Each service record is associated with an identifier of a service zone and a timestamp (e.g., when the service operation was performed, when the service operation was completed, when the service operation was input via GUI 200F of FIG. 2F). In some embodiments, the service data is received from a client device 110 responsive to a user (e.g., service staff) inputting service records into a GUI (e.g., see GUI 200F of FIG. 2F, displayed by the corrective action component 138).

In some embodiments, service data 142 includes a desired parameter for the service zone. In some examples, a desired parameter is a desired service rating (e.g., 5-star rating, 4-star rating) for the service zone. In some examples, a desired parameter is a desired standard compliance, such as CDC (The United States Centers for Disease Control and Prevention), WHO (The World Health Organization), USGBC (The U.S. Green Building Council), etc., for the service zone.

Feedback data 152 (e.g., historical feedback data 154 and current feedback data 156) includes one or more of a service work order, a supplies work order, a service ranking, and/or sensor data (e.g., received from sensors 104). A services ranking may be received from a client device 110 (e.g., of a patron of the service zone) responsive to user input via a GUI (e.g., see GUI 2C of FIG. 2C, displayed by the corrective action component 138). For example, a services ranking may be a star-rating of cleanliness of a service zone. A service work order and/or supplies work order may be received from a client device 110 responsive to user input via a GUI (e.g., see GUI 2D of FIG. 2D, displayed via corrective action component 138). Sensor data may be received from a sensor 104 or client device 110.

In some embodiments, the feedback data 152 includes an identifier. In some examples, the identifier is based on a client device 110 (e.g., of a patron of the service zone) scanning a quick response (QR) code located at the service zone (e.g., the QR code being associated with the identifier of the service zone). In some examples, the identifier is based on a client device 110 (e.g., of a patron of the service zone) receiving the identifier from a radio frequency identification (RFID) tag. In some examples, the identifier is based on user selection of the service zone via a GUI displayed via client device 110 (e.g., of a patron of the service zone). In some examples, the identifier is based on a current geographical location (e.g., of a location device, of a GPS location) of the client device 110 (e.g., of a patron of the service zone) that is proximate the service zone.

Performance data 162 (e.g., historical performance data 164 and current performance data 166) includes one or more of service operation schedule or configuration of the service zone. The service operation schedule may include a frequency of service operations (e.g., predefined times of service operations), types of service operations (e.g., types of cleaning, types of cleaning products used, types of equipment used, etc.), types of supplies used (e.g., low grade paper towels, medium grade paper towels, single ply toilet paper, double ply toilet paper, etc.). In some embodiments, configuration of the service zone includes design of the service zone, remodeling of the service zone, capacity of supplies dispensers at the service zone, etc.

Predictive data 168 includes a predictive performance data 162 based on the service data 142 and feedback data 152. For example, at a desired service rating, service operations, sensor data, etc., a predicted service operation schedule is to be followed.

In some embodiments, one or more of service data 142, feedback data 152, and/or performance data 162 is processed (e.g., by client device 110, server device 120, and/or predictive server 132). In some embodiments, processing of one or more of service data 142, feedback data 152, and/or performance data 162 includes generating features. In some embodiments, the features are a pattern in one or more of service data 142, feedback data 152, and/or performance data 162 (e.g., slope, width, height, peak, etc.) or a combination of values from one or more of service data 142, feedback data 152, and/or performance data 162 (e.g., power derived from voltage and current, etc.). In some embodiments, one or more of service data 142, feedback data 152, and/or performance data 162 includes features and the features are used by the predictive component 134 for obtaining predictive data 168 for performance of a corrective action.

Historical data includes one or more of historical service data 144, historical feedback data 154, and/or historical performance data 164 (e.g., at least a portion for training the machine learning model 190). Current data includes one or more of current service data 146, current feedback data 156, and/or current performance data 166 (e.g., at least a portion to be input into the trained machine learning model 190 subsequent to training the model 190 using the historical data) for which predictive data 168 is generated (e.g., for performing corrective actions). In some embodiments, the current data is used for retaining the trained machine learning model 190.

In some embodiments, predictive data 168 is associated with predictive performance data associated with a service zone (e.g., predicted schedule of service operations to have a threshold service rating). In some embodiments, the predictive data 168 is predictive performance data of the service zone after performing a particular corrective action.

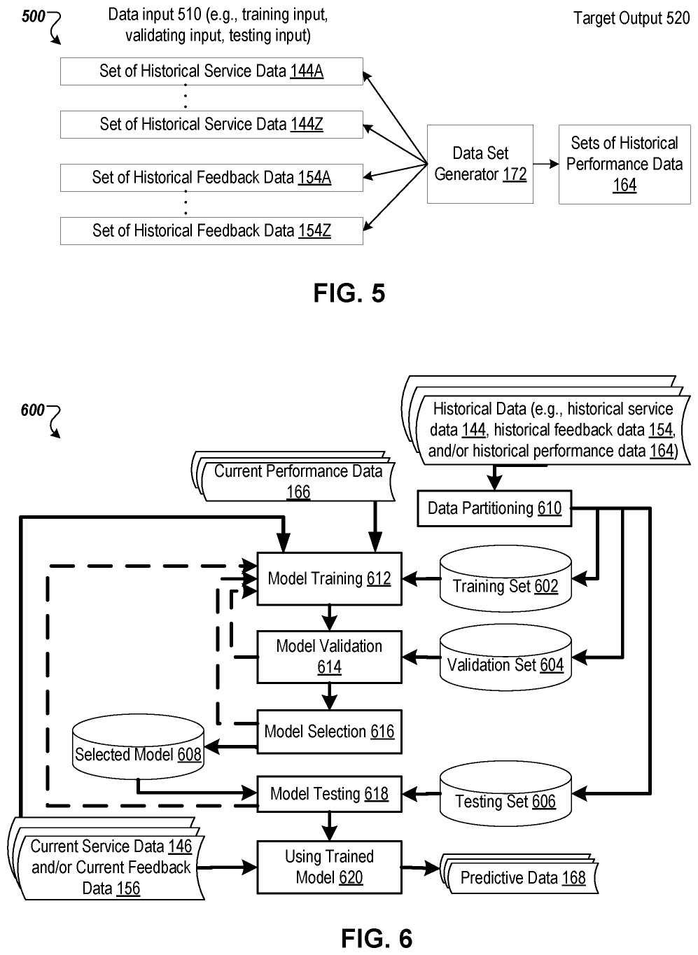

In some embodiments, predictive system 130 further includes server machine 170 and server machine 180. Server machine 170 includes a data set generator 172 that is capable of generating data sets (e.g., a set of data inputs and a set of target outputs) to train, validate, and/or test a machine learning model(s) 190. Some operations of data set generator 172 are described in detail below with respect to FIGS. 5 and 7A. In some embodiments, the data set generator 172 partitions the historical data (e.g., historical service data 144, historical feedback data 154, and historical performance data 164) into a training set (e.g., sixty percent of the historical data), a validating set (e.g., twenty percent of the historical data), and a testing set (e.g., twenty percent of the historical data). In some embodiments, the predictive system 130 (e.g., via predictive component 134) generates multiple sets of features. In some examples, a first set of features corresponds to a first set of types of service data 142 and/or feedback data 152 (e.g., from a first set of sensors, first combination of values from first set of sensors, first patterns in the values from the first set of sensors) that correspond to each of the data sets (e.g., training set, validation set, and testing set) and a second set of features correspond to a second set of types of service data 142 and/or feedback data 152 (e.g., from a second set of sensors different from the first set of sensors, second combination of values different from the first combination, second patterns different from the first patterns) that correspond to each of the data sets.

Server machine 180 includes a training engine 182, a validation engine 184, selection engine 185, and/or a testing engine 186. In some embodiments, an engine (e.g., training engine 182, a validation engine 184, selection engine 185, and a testing engine 186) refers to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 is capable of training a machine learning model 190 using one or more sets of features associated with the training set from data set generator 172. In some embodiments, the training engine 182 generates multiple trained machine learning models 190, where each trained machine learning model 190 corresponds to a distinct set of features of the training set (e.g., service data 142 and/or feedback data 152 from a distinct set of client devices 110 and/or sensors 104). In some examples, a first trained machine learning model was trained using all features (e.g., X1-X5), a second trained machine learning model was trained using a first subset of the features (e.g., X1, X2, X4), and a third trained machine learning model was trained using a second subset of the features (e.g., X1, X3, X4, and X5) that partially overlaps the first subset of features.

The validation engine 184 is capable of validating a trained machine learning model 190 using a corresponding set of features of the validation set from data set generator 172. For example, a first trained machine learning model 190 that was trained using a first set of features of the training set is validated using the first set of features of the validation set. The validation engine 184 determines an accuracy of each of the trained machine learning models 190 based on the corresponding sets of features of the validation set. The validation engine 184 discards trained machine learning models 190 that have an accuracy that does not meet a threshold accuracy. In some embodiments, the selection engine 185 is capable of selecting one or more trained machine learning models 190 that have an accuracy that meets a threshold accuracy. In some embodiments, the selection engine 185 is capable of selecting the trained machine learning model 190 that has the highest accuracy of the trained machine learning models 190.

The testing engine 186 is capable of testing a trained machine learning model 190 using a corresponding set of features of a testing set from data set generator 172. For example, a first trained machine learning model 190 that was trained using a first set of features of the training set is tested using the first set of features of the testing set. The testing engine 186 determines a trained machine learning model 190 that has the highest accuracy of all of the trained machine learning models based on the testing sets.

In some embodiments, the machine learning model 190 refers to the model artifact that is created by the training engine 182 using a training set that includes data inputs and corresponding target outputs (correct answers for respective training inputs). Patterns in the data sets can be found that map the data input to the target output (the correct answer), and the machine learning model 190 is provided mappings that captures these patterns. In some embodiments, the machine learning model 190 uses one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network), etc. In some embodiments, the machine learning model 190 is a multi-variable analysis (MVA) model.

Predictive component 134 provides current service data 146 and current feedback data 156 to the trained machine learning model 190 and runs the trained machine learning model 190 on the input to obtain one or more outputs. The predictive component 134 is capable of determining (e.g., extracting) predictive data 168 from the output of the trained machine learning model 190 and determines (e.g., extracts) confidence data from the output that indicates a level of confidence that the predictive data 168 corresponds to current performance data 166 (e.g., model 190) of the service zone at the current service data 146 and current feedback data 156. In some embodiments, the predictive component 134 or corrective action component 138 use the confidence data to decide whether to cause a corrective action associated with the service zone based on the predictive data 168.

The confidence data includes or indicates a level of confidence that the predictive data 168 corresponds to current performance data 166 (e.g., model 190) of the service zone at the current service data 146 and current feedback data 156. In one example, the level of confidence is a real number between 0 and 1 inclusive, where 0 indicates no confidence that the predictive data 168 corresponds to current performance data 166 associated with the current service data 146 and current feedback data 156 and 1 indicates absolute confidence that the predictive data 168 corresponds to current performance data 166 associated with the current service data 146 and current feedback data 156. Responsive to the confidence data indicating a level of confidence below a threshold level for a predetermined number of instances (e.g., percentage of instances, frequency of instances, total number of instances, etc.) the predictive component 134 causes the trained machine learning model 190 to be re-trained (e.g., based on the current service data 146, current feedback data 156, and current performance data 166).

For purpose of illustration, rather than limitation, aspects of the disclosure describe the training of one or more machine learning models 190 using historical data (e.g., historical service data 144, historical feedback data 154, and historical performance data 164) and inputting current data (e.g., current service data 146, current feedback data 156) into the one or more trained machine learning models 190 to determine predictive data 168 (e.g., predicting current performance data 166). In other implementations, a heuristic model or rule-based model is used to determine predictive data 168 (e.g., without using a trained machine learning model). Predictive component 134 monitors historical service data 144, historical feedback data 154, and historical performance data 164. In some embodiments, any of the information described with respect to data inputs 510 of FIG. 5 are monitored or otherwise used in the heuristic or rule-based model.

In some embodiments, the functions of server device 120, predictive server 132, server machine 170, and server machine 180 are be provided by a fewer number of machines. For example, in some embodiments, server machines 170 and 180 are integrated into a single machine, while in some other embodiments, server machine 170, server machine 180, and predictive server 132 are integrated into a single machine. In some embodiments, server device 120 and predictive server 132 are integrated into a single machine.

In general, functions described in one embodiment as being performed by server device 120, predictive server 132, server machine 170, and server machine 180 can also be performed on predictive server 132 in other embodiments, if appropriate. In addition, the functionality attributed to a particular component can be performed by different or multiple components operating together. For example, in some embodiments, the predictive server 132 determines the corrective action based on the predictive data 168. In another example, server device 120 determines the predictive data 168 based on output from the trained machine learning model.

In some embodiments, the corrective action component 138 is part of the predictive system 130 (e.g., predictive server 132). In some embodiments, the predictive component 134 is part of the server device 120. In some embodiments, the corrective action component 138 and/or the predictive component 134 is part of the client device 110.

In addition, the functions of a particular component can be performed by different or multiple components operating together. In some embodiments, one or more of the predictive server 132, server machine 170, or server machine 180 are accessed as a service provided to other systems or devices through appropriate application programming interfaces (API).

In some embodiments, a “user” is represented as a single individual. However, other embodiments of the disclosure encompass a “user” being an entity controlled by a plurality of users and/or an automated source. In some examples, a set of individual users federated as a group of administrators is considered a “user.”

Although embodiments of the disclosure are discussed in terms of generating predictive data 168 to perform a corrective action associated with a service zone, in some embodiments, the present disclosure can also be generally applied to providing corrective actions based on different types of data.

FIGS. 2A-F illustrate GUIs 200A-F associated with providing service operations, according to certain embodiments. Each of GUIs 200A-F may be displayed via a client device 110 of FIG. 1 (e.g., smartphone, tablet, computer, etc.). GUIs 200A-F may provide transparency and accountability in service operations.

Referring to FIG. 2A, GUI 200A can be displayed via a client device 110 of FIG. 1 during service operation time of the service zone.

GUI 200A includes a service zone identifier 210. The zone identifier 210 may display one or more of a zone number (e.g., zone #1295), a zone descriptor (e.g., lobby), address (e.g., 12950 Worldgate Drive), etc.

GUI 200A includes service data 212. Service data 212 may include service records and corresponding timestamps. For example, service data 212A may display the latest service record time (e.g., last serviced Friday, Feb. 18, 2022 12:33 pm), latest service record items (e.g., service items: cleaned), and/or the like. In some embodiments, service data 212A for the latest service record in one location of the GUI 200A and service data 212B-C for other service records are displayed on another location of the GUI 200A. For example, service data 212B may include a latest service record time (e.g., Thursday, Feb. 17, 2022 at 12:41 pm) and the latest service record item (e.g., cleaned).

GUI 200A includes a service countdown 214. The service countdown 214 may display remaining time (e.g., 4 hours, 2 minutes, and 34 seconds) until the next scheduled service operation of the service zone.

GUI 200A includes one or more subscription graphical elements 216. In some embodiments, subscription graphical element 216A is a link (e.g., sign up for SMS alerts) to subscription graphical element 216B. Subscription graphical element 216B may include a text field to enter contact information, such as a telephone number (e.g., subscribe and get real-time updates on spaces all around your building). Subscription graphical element 216B may include submission graphical element (e.g., Submit) for user interaction (e.g., for the user to click) after entering contact information.

GUI 200A includes a feedback graphical element 218 that includes text (e.g., Everything look good? Let us know!) that causes FIG. 2C to appear upon user interaction (e.g., clicking).

GUI 200A includes a service data graphical element 220 that is a link to show additional service data 212.

GUI 200A includes a login graphical element 222. Upon interaction with (e.g., clicking on) login graphical element 222, FIG. 200F may be displayed.

Referring to FIG. 2B, GUI 200B can be displayed via a client device 110 of FIG. 1 outside of service operation times of the service zone. GUI 200B includes the features of GUI 200A except for a time notification 230 overlaid on the service countdown 214. The time notification 230 may illustrate the hours of service operation. For example, the time notification may display: Zone not in service; Cleancode hours 7:00 AM-3:30 PM. Other features of GUI 200A may be visible on GUI 200B.

Referring to FIG. 2C, GUI 200C can be displayed via a client device 110 of FIG. 1 responsive of user interaction with the feedback graphical element 218 of FIG. 2A.

GUI 200C includes a feedback overlay 240 that may include a service rating graphical element 242, a cancelation graphical element 244, and a submission graphical element 246.

For example, the feedback overlay 240 may display text: Leave Feedback; Tell us What You Think; How would you rate the cleanliness? The service rating graphical element 242 may include a quantity of stars configured to receive user interaction (e.g., clicking on one or more stars) to indicate a service rating for the service zone. User interaction with the cancelation graphical element 244 cancels the submission of feedback data (e.g., the GUI 200C reverts to GUI 200A or 200B) and user interaction with the submission graphical element 246 submits the service rating as feedback data (e.g., to server device 120). The service rating submitted via GUI 200B may be stored in a data store as feedback data (e.g., feedback data 152 of data store 140 of FIG. 1).

GUI 200C includes a detailed feedback graphical element 248. Responsive to user interaction with the detailed feedback graphical element 248, GUI 200D may be displayed.

Referring to FIG. 2D, GUI 200D can be displayed via a client device 110 of FIG. 1 responsive of user interaction with the detailed feedback graphical element 248 of FIG. 2C.

GUI 200D includes a feedback overlay 250 that may include a name graphical element 252, email graphical element 254, phone graphical element 256, issue graphical element 258, cancelation graphical element 244, and a submission graphical element 246.

The feedback overlay 250 may display text: Zone Feedback; Does something need attention? Let us know how we can help. The name graphical element 252 may include a text box to receive user input of a name of the user. The email graphical element 254 may include a text box to receive user input of an email of the user. The phone graphical element 256 may include a text box to receive user input of a phone number of the user. The issue graphical element 258 may include a text box and/or drop-down options (e.g., items need to be cleaned, items need to be refilled, items need to be sanitized, items need to be disinfected, items need to be serviced, other, and/or the like). User interaction with the cancelation graphical element 244 cancels the submission of feedback data (e.g., the GUI 200D reverts to one of GUI 200A-C) and user interaction with the submission graphical element 246 submits one or more of the user inputs (e.g., name, email, phone, issue) as feedback data (e.g., to server device 120). The user inputs submitted via GUI 200C may be stored in a data store as feedback data (e.g., feedback data 152 of data store 140 of FIG. 1).

Referring to FIG. 2E, GUI 200E can be displayed via a client device 110 of FIG. 1 responsive of user interaction with the login graphical element 222 of FIG. 2A.

GUI 200E includes a login overlay 260 that may include login graphical element 262, cancelation graphical element 244, and submission graphical element 246.

The login overlay 260 may display text: Employee Access; Enter Your Code Below. The login graphical element 252 may include a text box to receive user input of an employee code (e.g., an employee code is unique to an employee). User interaction with the cancelation graphical element 244 cancels the submission of login data (e.g., the GUI 200E reverts to one of GUI 200A-B). Responsive to user interaction with the submission graphical element 246, GUI 200F may be displayed.

Referring to FIG. 2F, GUI 200F can be displayed via a client device 110 of FIG. 1 responsive of user interaction with submission graphical element 246 of FIG. 2E.

GUI 200F includes a service data overlay 270 that may include service data graphical element 272, cancelation graphical elements 244, and submission graphical element 246.

The service data overlay 270 may display text: Employee Access; What actions did you perform?” The service data graphical elements 272 may receive user interaction (e.g., click buttons) to indicate the service operations that were performed (e.g., cleaned, disinfected, refilled, sanitized, serviced, etc.). Service data overlay 270 may be customized by needs of the customer and/or facility (e.g., customized based on services that can be performed at the specific service zone and/or building). The service data graphical elements 272 may include a text box to receive user input of a service operation. User interaction with the cancelation graphical element 244 cancels the submission of the service data (e.g., the GUI 200F reverts to one of GUI 200A, 200B, or 200E). Responsive to user interaction with the submission graphical element 246, the service data is submitted (e.g., to server device 120). The service data submitted via GUI 200F may be stored in a data store (e.g., service data 142 of data store 140 of FIG. 1).

In some embodiments, service data graphical elements 272 may be configured to receive user input of a product that was used to perform service (e.g., clean, disinfect, sanitize, etc.) at the service zone. In some examples, the service data graphical elements 272 includes a drop-down list to receive selection of a cleaning product used. In some examples, the service data graphical elements 272 includes a text box to receive user input of a cleaning product used.

In some embodiments, one or more of the GUIs (e.g., GUIs 200A-F, GUI 300, etc.) displays information (e.g., “where to get more info”) associated with the product (e.g., cleaning product) used to service the service zone. In some embodiments, the information associated with the product includes one or more of the name of the product, benefits of the product (e.g., ecologically friendly product, provides a cleaner and/or healthier service zone, etc.), where to obtain more information about the product, information about the manufacturer of the product, information about retailers of the product (e.g., where to buy the product), etc. In some embodiments, information associated with the product used to service the service zone is displayed responsive to scanning an identifier (e.g., QR code).

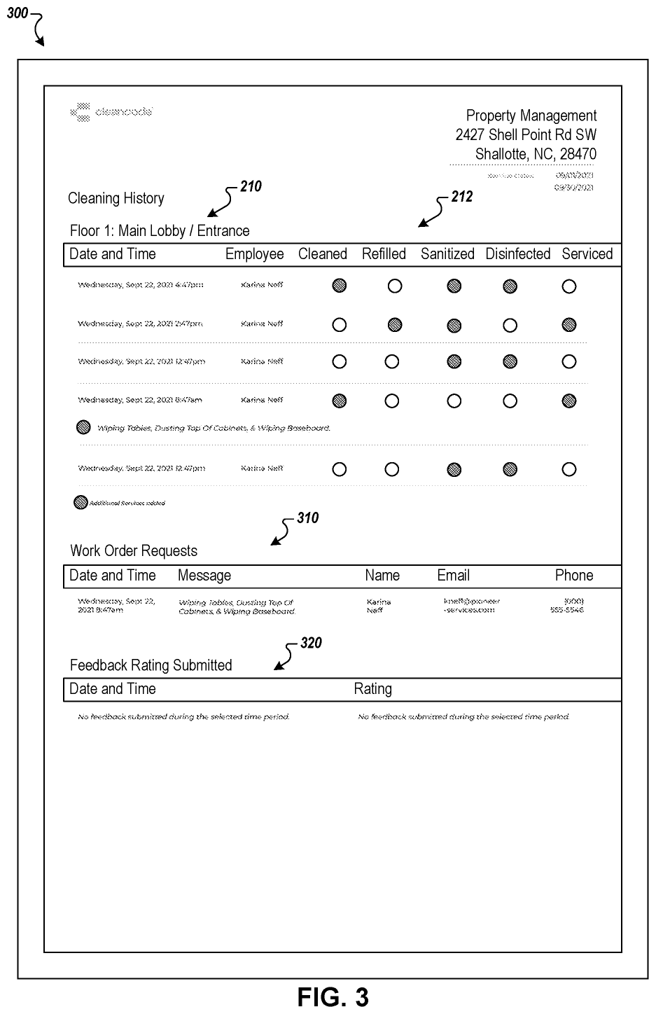

FIG. 3 illustrates a GUI 300 associated with providing service operations, according to certain embodiments. GUI 300 may be displayed via a client device 110 of FIG. 1 (e.g., smartphone, tablet, computer, etc.). GUI 300 may display service data and feedback data for a service zone. GUI 300 may display usage data, occupant engagement data, and/or visitor data.

GUI 300 may illustrate service zone identifier 210 (e.g., main lobby/entrance), service data 212, service work orders 310, and service ratings 320.

The service data 212 may include service records of a type of service operation performed (e.g., cleaned, refilled, sanitized, disinfected, serviced, etc.) and a corresponding timestamp.

The service work orders 310 may be responsive to user input via issue graphical element 258 of GUI 200D. The service work order 310 may be feedback data of unscheduled service operations that are requested (e.g., wiping tables, dusting top of cabinets, and wiping baseboard).

The service ratings 320 may be responsive to user input via service rating graphical element 242 of GUI 200C. The service ratings 310 may be feedback data of service ratings of quality of the service zone (e.g., before service operations, after service operations, between service operations).

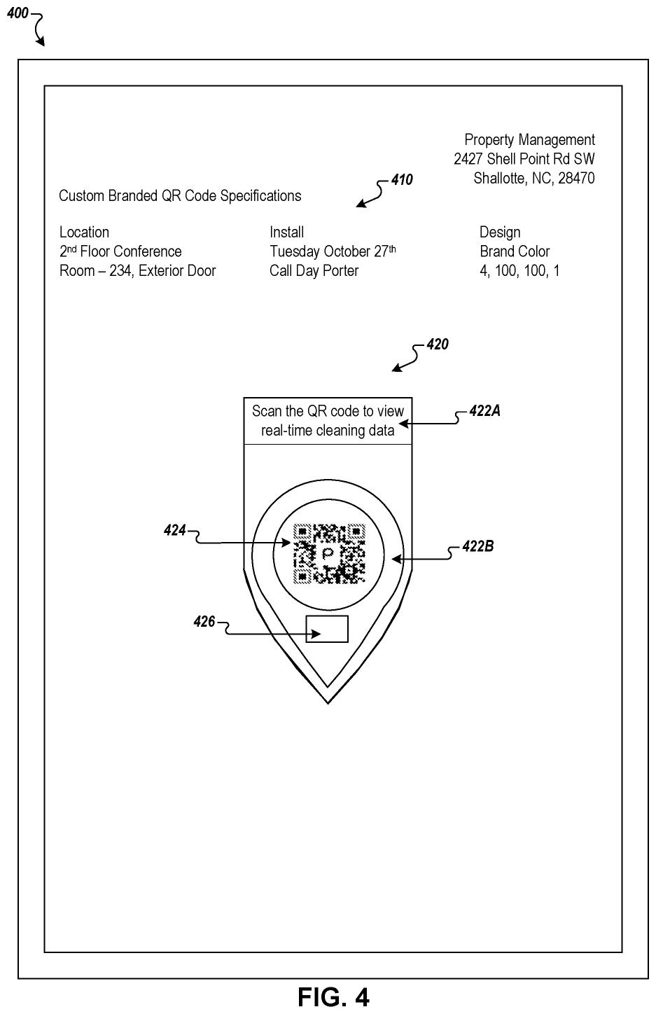

FIG. 4 illustrates a GUI 400 associated with providing service operations, according to certain embodiments. GUI 400 may be displayed via a client device 110 of FIG. 1 (e.g., smartphone, tablet, computer, etc.).

GUI 400 may display identifier installation data 410 associated with installation of a physical identifier (e.g., placard that displays a QR code) at a service zone. For example, the identifier installation data 410 may include location data of the service zone (e.g., 2^{nd} Floor Conference Room—234, Exterior Door), installation data of the physical identifier at the service zone (e.g., Tuesday, October 27^{th}, Call Day Porter), and design data of the physical identifier installed at the service zone (e.g., brand color).

GUI 400 may display identifier display data 420. The identifier display data 420 may be a graphical representation of the physical identifier that was installed at the service zone. The identifier display data 420 may include branding 422 (e.g., custom brand colors), an identifier 424 (e.g., custom branded QR code), and logo 426 (e.g., company logo area).

A physical identifier may be installed proximate the service zone (e.g., at the entrance of the service zone, on a wall proximate the door to enter the service zone, on the door of the service zone, etc.).

In some embodiments, a client device scans the physical identifier (e.g., the QR code) which causes GUI 200A of FIG. 2A to be displayed via the client device. Responsive to the user of the client device being service staff, the user selects login graphical element 222 of GUI 200A to input service data. Responsive to the user of the client device being a patron, the user selects feedback graphical element 218 of GUI 200A to input feedback data.

FIG. 5 illustrates data set generator 172 (e.g., data set generator 172 of FIG. 1) to create data sets for a machine learning model (e.g., model 190 of FIG. 1), according to certain embodiments. In some embodiments, data set generator 172 is part of server machine 170 of FIG. 1.

Data set generator 172 creates data sets for a machine learning model (e.g., model 190 of FIG. 1). Data set generator 172 creates data sets using historical service data 144, historical feedback data 154, and historical performance data 164. System 500 of FIG. 5 shows data set generator 172, data inputs 510, and target output 520.

In some embodiments, data set generator 172 generates a data set (e.g., training set, validating set, testing set) that includes one or more data inputs 510 (e.g., training input, validating input, testing input) and one or more target outputs 520 that correspond to the data inputs 510. The data set also includes mapping data that maps the data inputs 510 to the target outputs 520. Data inputs 510 are also referred to as “features,” “attributes,” or “information.” In some embodiments, data set generator 172 provides the data set to the training engine 182, validating engine 184, or testing engine 186, where the data set is used to train, validate, or test the machine learning model 190. Some embodiments of generating a training set are further described with respect to FIG. 7A.

In some embodiments, data set generator 172 generates the data input 510 and target output 520. In some embodiments, data inputs 510 include one or more sets of historical service data 144 and historical feedback data 154. Each instance of historical service data 144 and historical feedback data 154 includes one or more of data from one or more types of devices (e.g., client devices 110, sensors 104), combination of data from one or more types of devices, patterns from data from one or more types of devices, etc.

In some embodiments, data set generator 172 generates a first data input corresponding to a first set of historical service data 144A and historical feedback data 154A to train, validate, or test a first machine learning model and the data set generator 172 generates a second data input corresponding to a second set of historical service data 144B and historical feedback data 154B to train, validate, or test a second machine learning model.

In some embodiments, the data set generator 172 discretizes (e.g., segments) one or more of the data input 510 or the target output 520 (e.g., to use in classification algorithms for regression problems). Discretization (e.g., segmentation via a sliding window) of the data input 510 or target output 520 transforms continuous values of variables into discrete values. In some embodiments, the discrete values for the data input 510 indicate discrete historical service data 144 and historical feedback data 154 to obtain a target output 520 (e.g., discrete performance data 154).

Data inputs 510 and target outputs 520 to train, validate, or test a machine learning model include information for a particular location (e.g., service zone, room, building, city, region, etc.). In some examples, historical service data 144, historical feedback data 154, and historical performance data 164 are for the same service zone.

In some embodiments, the information used to train the machine learning model is from specific types and/or groups of service zones having specific characteristics (e.g., same type of service zone, such as restrooms, etc.) and allow the trained machine learning model to determine outcomes for same or similar types and/or groups of service zones having same or similar specific characteristics based on current service data 146 and current feedback data 156.

In some embodiments, subsequent to generating a data set and training, validating, or testing a machine learning model 190 using the data set, the machine learning model 190 is further trained, validated, or tested (e.g., current performance data 166 of FIG. 1) or adjusted (e.g., adjusting weights associated with input data of the machine learning model 190, such as connection weights in a neural network).

FIG. 6 is a block diagram illustrating a system 600 (e.g., predictive system 130 of FIG. 1) for generating predictive data 168 associated with providing service operations, according to certain embodiments. The system 600 is used to determine predictive data 168 (e.g., via model 190 of FIG. 1) to cause a corrective action associated with a service zone.

At block 610, the system 600 performs data partitioning (e.g., via data set generator 172 of server machine 170 of FIG. 1) of the historical data (e.g., historical service data 144, historical feedback data 154, and historical performance data 164 of FIG. 1) to generate the training set 602, validation set 604, and testing set 606. In some examples, the training set is 60% of the historical data, the validation set is 20% of the historical data, and the testing set is 20% of the historical data. The system 600 generates a plurality of sets of features for each of the training set, the validation set, and the testing set. In some examples, if the historical data includes features derived from data from 20 devices (e.g., client devices 110 and/or sensors 104 of FIGS. 1) and 100 iterations (e.g., iterations associated with providing service operations that each correspond to the data from the 20 devices, time frames), a first set of features is devices 1-10, a second set of features is devices 11-20, the training set is iterations 1-60, the validation set is iterations 61-80, and the testing set is iterations 81-100. In this example, the first set of features of the training set would be data from devices 1-10 for iterations 1-60.

At block 612, the system 600 performs model training (e.g., via training engine 182 of FIG. 1) using the training set 602. In some embodiments, the system 600 trains multiple models using multiple sets of features of the training set 602 (e.g., a first set of features of the training set 602, a second set of features of the training set 602, etc.). For example, system 600 trains a machine learning model to generate a first trained machine learning model using the first set of features in the training set (e.g., data from devices 1-10 for iterations 1-60) and to generate a second trained machine learning model using the second set of features in the training set (e.g., data from devices 11-20 for iterations 1-60). In some embodiments, the first trained machine learning model and the second trained machine learning model are combined to generate a third trained machine learning model (e.g., a better predictor than the first or the second trained machine learning model on its own in some embodiments). In some embodiments, sets of features used in comparing models overlap (e.g., first set of features being data from devices 1-15 and second set of features being devices 5-20). In some embodiments, hundreds of models are generated including models with various permutations of features and combinations of models.

At block 614, the system 600 performs model validation (e.g., via validation engine 184 of FIG. 1) using the validation set 604. The system 600 validates each of the trained models using a corresponding set of features of the validation set 604. For example, system 600 validates the first trained machine learning model using the first set of features in the validation set (e.g., data from devices 1-10 for iterations 61-80) and the second trained machine learning model using the second set of features in the validation set (e.g., data from devices 11-20 for iterations 61-80). In some embodiments, the system 600 validates hundreds of models (e.g., models with various permutations of features, combinations of models, etc.) generated at block 612. At block 614, the system 600 determines an accuracy of each of the one or more trained models (e.g., via model validation) and determines whether one or more of the trained models has an accuracy that meets a threshold accuracy. Responsive to determining that none of the trained models has an accuracy that meets a threshold accuracy, flow returns to block 612 where the system 600 performs model training using different sets of features of the training set. Responsive to determining that one or more of the trained models has an accuracy that meets a threshold accuracy, flow continues to block 616. The system 600 discards the trained machine learning models that have an accuracy that is below the threshold accuracy (e.g., based on the validation set).

At block 616, the system 600 performs model selection (e.g., via selection engine 185 of FIG. 1) to determine which of the one or more trained models that meet the threshold accuracy has the highest accuracy (e.g., the selected model 608, based on the validating of block 614). Responsive to determining that two or more of the trained models that meet the threshold accuracy have the same accuracy, flow returns to block 612 where the system 600 performs model training using further refined training sets corresponding to further refined sets of features for determining a trained model that has the highest accuracy.

At block 618, the system 600 performs model testing (e.g., via testing engine 186 of FIG. 1) using the testing set 606 to test the selected model 608. The system 600 tests, using the first set of features in the testing set (e.g., data from devices 1-10 for iterations 81-100), the first trained machine learning model to determine the first trained machine learning model meets a threshold accuracy (e.g., based on the first set of features of the testing set 606). Responsive to accuracy of the selected model 608 not meeting the threshold accuracy (e.g., the selected model 608 is overly fit to the training set 602 and/or validation set 604 and is not applicable to other data sets such as the testing set 606), flow continues to block 612 where the system 600 performs model training (e.g., retraining) using different training sets corresponding to different sets of features (e.g., data from different devices). Responsive to determining that the selected model 608 has an accuracy that meets a threshold accuracy based on the testing set 606, flow continues to block 620. In at least block 612, the model learns patterns in the historical data to make predictions and in block 618, the system 600 applies the model on the remaining data (e.g., testing set 606) to test the predictions.

At block 620, system 600 uses the trained model (e.g., selected model 608) to receive current service data 146 and current feedback data 156 and determines (e.g., extracts), from the output of the trained model, predictive data 168 to perform corrective actions associated with the service zone. In some embodiments, the current service data 146 and current feedback data 156 corresponds to the same types of features in the historical service data 144 and historical feedback data 154. In some embodiments, the current service data 146 and current feedback data 156 corresponds to a same type of features as a subset of the types of features in historical service data 144 and historical feedback data 154 that are used to train the selected model 608.

In some embodiments, current performance data 166 is received. The model 608 is re-trained based on the current data (e.g., current service data 146, current feedback data 156, and current performance data 166). In some embodiments, a new model is trained based on the current data.

In some embodiments, one or more of the operations 610-620 occur in various orders and/or with other operations not presented and described herein. In some embodiments, one or more of operations 610-620 are not be performed. For example, in some embodiments, one or more of data partitioning of block 610, model validation of block 614, model selection of block 616, and/or model testing of block 618 are not performed.

FIGS. 7A-E illustrate flow diagrams of methods 700E associated with providing service operations, according to certain embodiments. In some embodiments, methods 700A-E are performed by processing logic that includes hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, one or more of methods 700A-E are performed, at least in part, by predictive system 130, client device 110, and/or server device 120 of FIG. 1. In some embodiments, method 700A is performed, at least in part, by predictive system 130 (e.g., server machine 170 and data set generator 172 of FIG. 1, data set generator 172 of FIG. 5). In some embodiments, predictive system 130 uses method 700A to generate a data set to at least one of train, validate, or test a machine learning model. In some embodiments, methods 700A-B are performed by server device 120 and/or predictive system 130. In some embodiments, method 700D is performed by server machine 180 (e.g., training engine 182, etc.). In some embodiments, method 700E is performed by predictive server 112 (e.g., predictive component 114). In some embodiments, a non-transitory machine-readable storage medium stores instructions that when executed by a processing device (e.g., of predictive system 130, of server machine 180, of predictive server 112, client device 110, server device 120, etc.), cause the processing device to perform one or more of methods 700A-E. In some embodiments, any of the methods described herein are performed by server device 120 and/or client device 110.

For simplicity of explanation, methods 700A-E are depicted and described as a series of operations. However, operations in accordance with this disclosure can occur in various orders and/or concurrently and with other operations not presented and described herein. Furthermore, in some embodiments, not all illustrated operations are performed to implement methods 700A-E in accordance with the disclosed subject matter. In addition, those skilled in the art will understand and appreciate that methods 700A-E could alternatively be represented as a series of interrelated states via a state diagram or events.

FIG. 7A is a flow diagram of a method 700A for generating a data set for a machine learning model for generating predictive data (e.g., predictive data 168 of FIG. 1), according to certain embodiments.

Referring to FIG. 7A, in some embodiments, at block 701 the processing logic implementing method 700A initializes a training set T to an empty set.

At block 702, processing logic generates first data input (e.g., first training input, first validating input, first testing input, etc.) that includes service data (e.g., historical service data 144 of FIGS. 1, 5, and/or 6) and feedback data (e.g., historical feedback data 154 of FIGS. 1, 5, and/or 6). In some embodiments, the first data input includes a first set of features for types of service data and/or feedback data and a second data input includes a second set of features for types of service data and/or feedback data (e.g., as described with respect to FIG. 5).

At block 703, processing logic generates a first target output for one or more of the data inputs (e.g., first data input). In some embodiments, the first target output is historical performance data (e.g., historical performance data 164 of FIGS. 1, 5, and/or 6). In some embodiments, the historical performance data is associated with performance of a corrective action.

At block 704, processing logic optionally generates mapping data that is indicative of an input/output mapping. The input/output mapping (or mapping data) refers to the data input (e.g., one or more of the data inputs described herein), the target output for the data input (e.g., where the target output identifies historical performance data 164), and an association between the data input(s) and the target output.

At block 705, processing logic adds the mapping data generated at block 704 to data set T.

At block 706, processing logic branches based on whether data set T is sufficient for at least one of training, validating, and/or testing machine learning model 190. If so, execution proceeds to block 707, otherwise, execution continues back at block 702. It should be noted that in some embodiments, the sufficiency of data set T is determined based simply on the number of input/output mappings in the data set, while in some other implementations, the sufficiency of data set T is determined based on one or more other criteria (e.g., a measure of diversity of the data examples, accuracy, etc.) in addition to, or instead of, the number of input/output mappings.

At block 707, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 510) are input to the neural network, and output values (e.g., numerical values associated with target outputs 520) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 707, machine learning model (e.g., machine learning model 190) can be at least one of trained using training engine 182 of server machine 180, validated using validating engine 184 of server machine 180, or tested using testing engine 186 of server machine 180. The trained machine learning model is implemented by predictive component 114 (of predictive server 112) to generate predictive data 168 for performing corrective action associated with a service zone.

FIG. 7B is a flow diagram of a method 700B associated with causing performance of a corrective action associated with a service zone, according to certain embodiments. In some embodiments, one or more operations of method 700B are performed by predictive system 130, predictive server 132, client device 110, or server device 120 of FIG. 1.

Referring to FIG. 7B, at block 720 processing logic identifies service data and feedback data associated with a service zone.

In some embodiments, the service zone is an indoor space (e.g., restroom, common area, lobby, main lobby/entrance, conference room, hotel room, airport gate, school, classroom, store front, etc.), an outdoor space (e.g., a lawn, landscaping, windows, etc.), an industrial area, and/or the like.

In some embodiments, the service data includes service records and corresponding timestamps. Service records can correspond to one or more of a cleaning operation, disinfection operation, refilling (re-supplying) operation, sanitizing operation, servicing operation, landscaping operation, maintenance operation, etc. Service data may be input via GUI 200F of FIG. 2F. In some embodiments, service data includes a current service operations schedule (e.g., schedule of predetermined times of when service staff is to perform service operations for the service zone). In some embodiments, service data includes a desired service rating (e.g., five-stars, four-stars) or standards compliance (e.g., USGBC, CDC, WHO, etc.).

In some embodiments, the feedback data includes service work order, supplies work order, service ranking, and/or sensor data. A service work order may be a request for a service operation. A supplies work order may be a request for refilling/re-supplying supplies at the service zone (e.g., toilet paper, paper towels, soap, hand sanitizer, etc.). The service work order and/or supplies work order may be input via issue graphical element 258 of FIG. 2D (e.g., items need to be cleaned, refilled, sanitized, disinfected, serviced, and/or the like).

A service ranking may be a ranking of the cleanliness of the service zone. The service ranking may be input via GUI 240 of FIG. 2C.

Sensor data may be received via a sensor or a client device. Sensor data may include image data (e.g., photos, videos), temperature data, occupancy data, air quality data (e.g., CO₂ data), and/or the like. In some embodiments, the sensor data is received from a different system (e.g., via an API). The sensor data may include air quality data (CO₂ data), weather data (e.g., snowfall data, rainfall data), heating ventilation and air conditioning (HVAC) system data, building automation system data, occupancy data, entrance data, etc.

At block 722, processing logic determines, based on the service data and feedback data, a corrective action associated with the service zone.

In some embodiments, determining of the corrective action of block 722 of FIG. 7B is by providing input of service data and feedback data of block 720 of FIG. 7B to a trained machine learning model (e.g., see FIG. 1, FIGS. 5-6, and FIG. 7E).

In some embodiments, corrective action includes one or more of providing an alert, providing a recommendation, updating the schedule of service operations, dispatching service staff to perform cleaning operations, interrupting operation of the service zone (e.g., closing the service zone), etc.

Updating the schedule of service operations may include adjusting the frequency of service operations (e.g., performing service operations 8 times per day instead of 4 times per day), updating the frequency of deep cleaning operations (e.g., title scrubbing, etc.), updating types of servicing operations to be performed (e.g., carpet cleaning type, specific vacuum brush system, static floor tool), updating the frequency of refilling (e.g., re-stocking, re-supplying) operations, updating the type of supplies used (e.g., low-grade paper towels, mid-grade paper towels, a specific brand, etc.), updating the type of cleaning product used, and/or the like.

In some embodiments, the corrective action includes increasing the capacity and/or quantity of supplies provided in the service zone (e.g., providing an additional paper towel dispenser, providing an additional hand air dryer, providing a toilet paper dispenser with larger toilet paper square capacity). In some embodiments, the corrective action includes a preventative or predictive maintenance schedule.

In some embodiments, the corrective action is to comply with warranties and/or third party certifications. In some embodiments, the corrective action is to reduce user harm (e.g., reduce slip and fall incidents, reduce accidents), reduce energy used, reduce environmental impact, and/or the like.

In some embodiments, the corrective action is determined by comparing sensor data (e.g., image data) from the feedback data to threshold sensor data. For example, if the CO₂ data meets a first threshold, then the corrective action is to have a first frequency of service operations (e.g., update the schedule of service operations).

At block 724, processing logic causes performance of the corrective action associated with the service zone. The processing logic may cause performance of the corrective action by communicating with one or more client devices. In some embodiments, the corrective action is to be performed for the service zone to meet a desired service rating. Method 700B may be repeated until the service zone meets the desired service rating.

FIG. 7C is a method 700C associated with service rankings for service zones, according to certain embodiments.

At block 730, processing logic receives, via a client device, user input including a type of service zone. The type of service zone may include one or more of a restaurant (e.g., that has a restroom), a type of restaurant (e.g., that has a restroom), a hotel (e.g., with specific amenities), a type of store, etc.

At block 732, processing logic determines a geographical location. The processing logic may determine the geographical location based on the current location of the client device (e.g., via GPS of the client device). The processing logic may determine the geographical location based on user input via the client device.

At block 734, processing logic identifies service zones that match the type of service zone and are within a threshold distance of the geographical location. For example, the processing logic may identify restaurants that have restrooms within the threshold distance of the client device.

At block 736, processing logic identifies corresponding service rankings of the service zones. Service rankings may be based on one or more of rankings by patrons (e.g., via GUI 200C of FIG. 2C), work orders by patrons (e.g., via GUI 200D), ratings by building owners, ratings by building tenants, ratings by service staff, etc. Service rankings may be an average of different types of rankings. For example, if the business owner gives the service zone a service ranking of 5 out of 5 and the service staff gives the service zone a service ranking of 4 out of 5, an average service ranking of 4.5 out of 5 may be used.

At block 738, processing logic causes the client device to display the service zones and the corresponding service rankings. In some embodiments, the processing logic causes the client device to display a list of service zones based on the service rankings (e.g., highest rankings listed above lower rankings). In some embodiments, the processing logic causes the client device to display a map of service zones with corresponding service rankings based on geographical locations of the service zones. In some embodiments, the processing logic shows the highest ranked service zones (e.g., in a list, on a map). In some embodiments, the processing logic weights the rankings of service zones based on service ratings, proximity to the current location of the client device, etc.

FIG. 7D is a method 700D for training a machine learning model (e.g., model 190 of FIG. 1) for determining predictive data (e.g., predictive data 168 of FIG. 1) to perform a corrective action associated with a service zone, according to certain embodiments.

Referring to FIG. 7D, at block 740 of method 700D, the processing logic receives historical service data (e.g., historical service data 144 of FIG. 1) and historical feedback data (e.g., historical feedback data 154 of FIG. 1) associated with historical service zones. In some embodiments, the historical service data and/or historical feedback data is collected over time from different devices (e.g., client devices 110 and sensors 104 of FIG. 1). Historical service data and historical feedback data may be similar to the service data and feedback data of block 720 of FIG. 7B. The historical service data and/or historical feedback data may include a service rating of the historical service zone (e.g., an average number of stars out of five stars that the historical service zones received).

At block 742, the processing logic receives historical performance data (e.g., historical performance data 164 of FIG. 1) associated with the historical service zones. Each of the historical performance data corresponds to respective historical service data and respective historical feedback data. The historical performance data may include a frequency of service operations, a schedule of service operations, type of service operations, products used in service operations, equipment used in service operations, configuration of the service zone, capacity and/or quantity of supplies in the service zone, type of supplies in the service zone, etc.

At block 744, the processing logic trains a machine learning model using data input including the historical service data and historical feedback data and target output including the historical performance data to generate a trained machine learning model. The trained machine learning model may match specific service data and feedback data to specific performance data to be able to achieve a particular service rating (e.g., star rating).

The trained machine learning model is capable of generating outputs indicative of predictive data (e.g., predictive data 168) to cause performance of one or more corrective actions (e.g., based on current service data and current feedback data) associated with the service zone. The corrective actions may be similar to the corrective actions of blocks 722-724 of FIG. 7B.

FIG. 7E is a method 700E for using a trained machine learning model (e.g., model 190 of FIG. 1) for determining predictive data to cause performance of a corrective action associated with a service zone, according to certain embodiments.

Referring to FIG. 7E, at block 760 of method 700E, the processing logic identifies current service data and current feedback data associated with a service zone. Current service data and current feedback data may be similar to the service data and feedback data of block 720 of FIG. 7B. The current service data and/or current feedback data may include a desired service rating of the service zone (e.g., an average number of stars out of five stars that are desired for the service zone).

At block 762, the processing logic provides the current service data and the current feedback data as input to a trained machine learning model (e.g., the trained machine learning model of block 744 of FIG. 7D).

At block 764, the processing logic obtains, from the trained machine learning model, one or more outputs indicative of predictive data. In some embodiments, the predictive data is associated with predicted performance data resulting from performance of one or more corrective actions, lack of performance of a corrective action, a schedule of performing corrective actions, type of corrective actions, and/or the like.

At block 766, the processing logic causes, based on the one or more outputs (e.g., predictive data), performance of a corrective action associated with the service zone. The corrective action may be similar to the corrective action of blocks 722-724 of FIG. 7B. The corrective action may include using an updated schedule of service operations that are predicted to allow the service zone to achieve the desired service rating

At block 768, processing logic receives current performance data (e.g., current performance data 166 of FIG. 1) associated with the service zone. The performance data may be the updated schedule of service operations that was implemented. The processing logic may also identify current service data and feedback data associated responsive to implementation of the updated schedule of service operations.

At block 770, processing logic causes the trained machine learning model to be further trained (e.g., re-trained) with data input including the current service data and current feedback data and target output including the current performance data (e.g., from block 768).

In some embodiments, blocks 760-764 are repeated until service rankings of the service zone equal the desired service ranking (e.g., desired star rating) for the service zone.

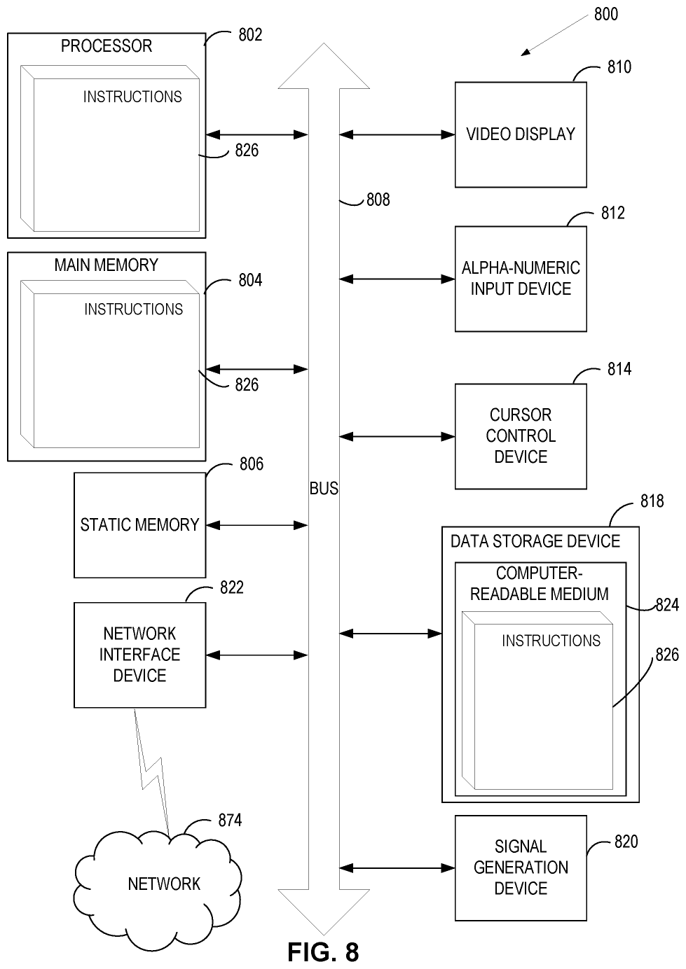

FIG. 8 is a block diagram illustrating a computer system 800, according to certain embodiments. In some embodiments, the computer system 800 is one or more of client device 110, server device 120, predictive system 130, server machine 170, server machine 180, predictive server 112, etc.

In some embodiments, computer system 800 is connected (e.g., via a network, such as a Local Area Network (LAN), an intranet, an extranet, or the Internet) to other computer systems. In some embodiments, computer system 800 operates in the capacity of a server or a client computer in a client-server environment, or as a peer computer in a peer-to-peer or distributed network environment. In some embodiments, computer system 800 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein (e.g., one or more of methods 700A-E of FIGS. 7A-E, etc.).

In a further aspect, the computer system 800 includes a processing device 802, a volatile memory 804 (e.g., Random Access Memory (RAM)), a non-volatile memory 806 (e.g., Read-Only Memory (ROM) or Electrically-Erasable Programmable ROM (EEPROM)), and a data storage device 816, which communicate with each other via a bus 808.

In some embodiments, processing device 802 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 800 further includes a network interface device 822 (e.g., coupled to network 874). In some embodiments, computer system 800 also includes a video display unit 810 (e.g., an LCD), an alphanumeric input device 812 (e.g., a keyboard), a cursor control device 814 (e.g., a mouse), and a signal generation device 820.

In some implementations, data storage device 816 includes a non-transitory computer-readable storage medium 824 on which store instructions 826 encoding any one or more of the methods or functions described herein, including instructions for implementing methods described herein.

In some embodiments, instructions 826 also reside, completely or partially, within volatile memory 804 and/or within processing device 802 during execution thereof by computer system 800, hence, in some embodiments, volatile memory 804 and processing device 802 also constitute machine-readable storage media.

While computer-readable storage medium 824 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In some embodiments, the methods, components, and features described herein are implemented by discrete hardware components or are integrated in the functionality of other hardware components such as ASICS, FPGAs, DSPs or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “identifying,” “determining,” “causing,” “receiving,” “training,” “providing,” “generating,” “obtaining,” “interrupting,” “transmitting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms “first,” “second,” “third,” “fourth,” etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein, or includes a general purpose computer system selectively programmed by a computer program stored in the computer system. Such a computer program is stored in a computer-readable tangible storage medium.

Some of the methods and illustrative examples described herein are not inherently related to any particular computer or other apparatus. In some embodiments, various general purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms “first,” “second,” “third,” “fourth,” etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ±10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
identifying service data associated with a service zone, wherein the service data comprises a plurality of service records and a corresponding timestamp for each of the plurality of service records;
identifying feedback data associated with the service zone, wherein the feedback data comprises one or more of a service work order, a supplies work order, a service ranking, or sensor data;
determining, based on the service data and the feedback data, a corrective action associated with the service zone; and
causing performance of the corrective action associated with the service zone.

2. The method of claim 1, wherein each service record of the plurality of service records corresponds to one or more of a cleaning operation, disinfection operation, or re-supplying operation performed at the service zone.

3. The method of claim 1, wherein the sensor data comprises one or more of image data, chemical data, air quality data, or occupancy data.

4. The method of claim 1, wherein the service zone comprises one or more of a restroom, a common area, or an indoor space.

5. The method of claim 1, wherein the feedback data comprises an identifier based on one or more of:
a client device scanning a quick response (QR) code associated with the identifier;
the client device receiving the identifier from a radio frequency identification (RFID) tag;
user selection of the service zone via a graphical user interface (GUI) displayed via the client device; or
a current geographical location of the client device that is proximate the service zone.

6. The method of claim 5 further comprising, responsive to receiving the identifier associated with the service zone from the client device, causing the client device to display the GUI comprising one or more of:
a countdown until a scheduled servicing of the service zone;
a graphical representation of one or more of the plurality of service records;
a first graphical element configured to receive, via first user input, the service work order, the supplies work order, or the service ranking associated with the service zone; or
a second graphical element configured to receive second user input to subscribe to service notifications associated with the service zone.

7. The method of claim 1 further comprising:
receiving, via a client device, user input comprising a type of service zone;
determining a geographical location associated with the type of service zone,
identifying a plurality of service zones that match the type of service zone and are within a threshold distance of the geographical location;
identifying corresponding service rankings of the plurality of service zones, the corresponding service rankings being based on the feedback data; and
causing the client device to display the plurality of service zones and the corresponding service rankings.

8. The method of claim 1 further comprising:
identifying historical service data and historical feedback data associated with historical service zones;
identifying historical performance data associated with the historical service zones, the historical performance data comprising one or more of historical service operation schedules or a configuration of the historical service zones; and
training a machine learning model with data input including the historical service data and the historical feedback data, and target output comprising the historical performance data to generate a trained machine learning model configured to predict the corrective action based on the sensor data and the feedback data.

9. The method of claim 1, wherein the determining of the corrective action comprises:
providing the service data and the feedback data as input to a trained machine learning model; and
receiving, from the trained machine learning model, output associated with predictive data, wherein the corrective action is determined based on the predictive data.

10. The method of claim 1, wherein the performance of the corrective action comprises one or more of:
providing an alert to a client device;
causing a service operation comprising one or more of a cleaning operation, a disinfection operation, or a re-supplying operation;
causing a service operation schedule to be updated; or
causing a reconfiguration of the service zone.

11. A non-transitory machine-readable storage medium storing instructions which, when executed cause a processing device to perform operations comprising:
identifying service data associated with a service zone, wherein the service data comprises a plurality of service records and a corresponding timestamp for each of the plurality of service records;
identifying feedback data associated with the service zone, wherein the feedback data comprises one or more of a service work order, a supplies work order, a service ranking, or sensor data;
determining, based on the service data and the feedback data, a corrective action associated with the service zone; and
causing performance of the corrective action associated with the service zone.

12. The non-transitory machine-readable storage medium of claim 11, wherein each service record of the plurality of service records corresponds to one or more of a cleaning operation, disinfection operation, or re-supplying operation performed at the service zone.

13. The non-transitory machine-readable storage medium of claim 11, wherein the sensor data comprises one or more of image data, chemical data, air quality data, or occupancy data.

14. The non-transitory machine-readable storage medium of claim 11, wherein the service zone comprises one or more of a restroom, a common area, or an indoor space.

15. The non-transitory machine-readable storage medium of claim 11, wherein the feedback data comprises an identifier based on one or more of:
a client device scanning a quick response (QR) code associated with the identifier;
the client device receiving the identifier from a radio frequency identification (RFID) tag;
user selection of the service zone via a graphical user interface (GUI) displayed via the client device; or
a current geographical location of the client device that is proximate the service zone.

16. The non-transitory machine-readable storage medium of claim 15, wherein the operations further comprise, responsive to receiving the identifier associated with the service zone from the client device, causing the client device to display the GUI comprising one or more of:
a countdown until a scheduled servicing of the service zone;
a graphical representation of one or more of the plurality of service records;
a first graphical element configured to receive, via first user input, the service work order, the supplies work order, or the service ranking associated with the service zone; or
a second graphical element configured to receive second user input to subscribe to service notifications associated with the service zone.

17. The non-transitory machine-readable storage medium of claim 11, wherein the operations further comprise:
receiving, via a client device, user input comprising a type of service zone;
determining a geographical location associated with the type of service zone,
identifying a plurality of service zones that match the type of service zone and are within a threshold distance of the geographical location;
identifying corresponding service rankings of the plurality of service zones, the corresponding service rankings being based on the feedback data; and
causing the client device to display the plurality of service zones and the corresponding service rankings.

18. The non-transitory machine-readable storage medium of claim 11, wherein the operations further comprise:
identifying historical service data and historical feedback data associated with historical service zones;
identifying historical performance data associated with the historical service zones, the historical performance data comprising one or more of historical service operation schedules or a configuration of the historical service zones; and
training a machine learning model with data input including the historical service data and the historical feedback data, and target output comprising the historical performance data to generate a trained machine learning model configured to predict the corrective action based on the sensor data and the feedback data.

19. The non-transitory machine-readable storage medium of claim 11, wherein the determining of the corrective action comprises:
providing the service data and the feedback data as input to a trained machine learning model; and
receiving, from the trained machine learning model, output associated with predictive data, wherein the corrective action is determined based on the predictive data.

20. A system comprising:
memory; and
a processing device coupled to the memory, wherein the processing device is to:
identify service data associated with a service zone, wherein the service data comprises a plurality of service records and a corresponding timestamp for each of the plurality of service records;
identify feedback data associated with the service zone, wherein the feedback data comprises one or more of a service work order, a supplies work order, a service ranking, or sensor data;
determine, based on the service data and the feedback data, a corrective action associated with the service zone; and
cause performance of the corrective action associated with the service zone.
